(19) United States
(12) Patent Application Publication
(10) Pub. No.: US 2026/0203694 A1
(43) Pub. Date: Jul. 16, 2026

(54) SYSTEM FOR FRAUD DETECTION AND AUTHENTICITY VERIFICATION IN AGRICULTURAL SUPPLY CHAINS USING ARTIFICIAL INTELLIGENCE

(71) Applicant: Sanchita SAHA, Los Angeles, CA (US)

(72) Inventor: Sanchita SAHA, Los Angeles, CA (US)

(21) Appl. No.: 19/556,966

(22) Filed: Mar. 4, 2026

(51) Int. Cl. G06Q 10/0635; G06Q 50/02; H04L 9/32

(52) U.S. Cl. CPC G06Q 10/0635; G06Q 50/02; H04L 9/3236

(57) ABSTRACT

The present invention relates to a system and method for fraud detection and authenticity verification in agricultural supply chains using artificial intelligence. The invention integrates distributed multimodal data acquisition, structured digital representation of commodity life cycles, artificial intelligence-based anomaly detection, compositional and spectral authenticity comparison, and cryptographic ledger anchoring to provide end-to-end traceability and risk assessment. The system collects environmental, transactional, identity, and compositional data from multiple supply chain nodes and transforms the data into a normalized graph-based representation of custody events and transformations. An artificial intelligence processor analyzes behavioral patterns, environmental deviations, and structural irregularities to generate a fraud risk score, while an authenticity comparison processor evaluates similarity between measured commodity signatures and stored reference profiles. A cryptographic integrity processor generates time-stamped hash values of validated records and anchors them into a distributed ledger to ensure immutability and tamper resistance.

### FIELD OF THE INVENTION

The present invention relates to digital monitoring and verification technologies for agricultural logistics. More particularly, the invention relates to a system and method for fraud detection and authenticity verification in agricultural supply chains using artificial intelligence, cryptographic traceability, multi-sensor data acquisition, and intelligent risk evaluation. The invention further relates to a dedicated device structured as a field-deployable authentication and traceability machine for agricultural commodities.

### BACKGROUND OF THE INVENTION

Agricultural supply chains are highly fragmented and involve multiple intermediaries including farmers, aggregators, transporters, warehouses, processors, exporters, and retailers. The distributed nature of operations creates opportunities for fraudulent practices such as product adulteration, origin misrepresentation, substitution of certified goods, falsified documentation, tampering during transportation, and counterfeiting of organic or geographical indication labels. Conventional traceability systems rely primarily on paper documentation, static barcode labels, or centralized databases that are vulnerable to data manipulation, duplication, and post-facto modification.

Existing digital systems do not provide real-time anomaly detection based on behavioral patterns across the supply chain. They further lack integration between sensor-based environmental monitoring, document verification, blockchain anchoring, and artificial intelligence-driven predictive analytics. As a result, detection of fraud typically occurs after significant economic damage has occurred.

Accordingly, there exists a need for an intelligent, tamper-resistant, multi-layered verification architecture capable of continuously monitoring agricultural commodities from origin to end distribution, identifying anomalies in product characteristics and logistics behavior, and authenticating product provenance using secure cryptographic mechanisms.

Agricultural supply chains have historically relied on a mix of manual processes, paper records, and siloed digital systems to manage provenance, quality, and regulatory compliance. Traditional approaches center on human-generated documentation, physical seals, and periodic laboratory analysis to verify origin and composition. While these methods are familiar and relatively low-cost at the point of origin, they are brittle when exposed to the scale and fluidity of modern supply chains. Paper trails can be forged, physical seals can be tampered with during transit, and laboratory testing is episodic and slow; together these limitations create windows of opportunity for substitution, adulteration, and misrepresentation that may not be detected until goods reach downstream stakeholders or consumers. Moreover, manual record keeping and isolated tests do not generate the continuous, high-frequency telemetry needed to detect behavioral anomalies in logistics such as unexpected custody transfers, atypical transit durations, or subtle environmental deviations that correlate strongly with fraud or spoilage.

In response to these shortcomings, industry actors have widely adopted automated identification technologies such as barcodes, two-dimensional QR codes, and radio-frequency identification (RFID). These identifiers make it possible to attach a persistent digital handle to physical batches, enabling faster scanning and the aggregation of event logs into enterprise resource planning systems and centralized traceability databases. The convenience of these technologies has been transformative for inventory management and recall efficiency, but they do not, by themselves, solve authenticity or tampering problems: barcodes and QR codes can be copied or relabeled, RFID tags can be removed or cloned, and the data recorded at scan points is only as trustworthy as the processes and actors that perform the scans. Centralized traceability databases, meanwhile, centralize control but create single points of failure and are vulnerable to insider threats, data manipulation, and outages. They also often suffer from poor interoperability across different participants who operate diverse software stacks and whose commercial incentives do not always align to share high-fidelity data.

To increase trustworthiness, several solutions have turned to distributed ledger technologies and blockchain-based anchoring of supply chain events. By hashing event records and anchoring them into immutable distributed ledgers, these systems aim to prevent retroactive tampering and provide a verifiable audit history. Permissioned blockchain networks deployed by consortia of producers, processors, and regulators can solve some trust issues between known parties and enable smart-contract-based enforcement of business rules. However, blockchain approaches introduce costs and technical friction: transaction throughput and latency can be problematic for high-frequency telemetry; on-chain storage is expensive so systems typically store only fingerprints rather than raw sensor streams, requiring off-chain storage and careful management of pointers and mirrors; consensus mechanisms and governance models must be negotiated across stakeholders, which is non-trivial; and the immutability of records complicates correction of honest errors and regulatory right-to-be-forgotten requirements. Additionally, blockchain does not inherently guarantee the veracity of the data being hashed—if upstream sensors or human inputs are compromised, the blockchain will faithfully preserve falsehoods.

The proliferation of Internet-of-Things (IoT) sensors and low-cost telemetry has enabled more continuous monitoring of environmental parameters—temperature, humidity, shock/vibration, geolocation, and atmosphere composition—during transport and storage. These sensors can be embedded in packaging, containers, and vehicles, providing time-series profiles that are highly informative about product handling. The benefits are substantial: continuous telemetry supports condition-based alerts, automated claims processing, and richer provenance narratives. Yet IoT deployments in agricultural contexts face practical obstacles. Low-cost sensors can drift or fail, requiring regular calibration and maintenance that is costly and impractical across millions of smallholder operations. Connectivity in rural areas is intermittent, forcing devices to operate offline with buffered logs that create eventual-consistency challenges. Moreover, many sensors are physically accessible and susceptible to spoofing or replacement; securing device identity and attestation typically requires hardware-backed secure elements, which increase bill-of-materials costs. The data deluge from distributed sensors also strains integration pipelines, necessitating normalization, deduplication, and robust metadata management—functions that many incumbent systems were not designed to perform.

Analytical advances have introduced statistical and machine learning approaches to detect anomalies and infer authenticity. Supervised classifiers can distinguish legitimate from adulterated samples when sufficiently labeled examples exist, while unsupervised anomaly detection algorithms and graph-based analytics can flag unusual transactional or behavioral patterns without explicit labels. Spectral analysis methods—near-infrared (NIR), Fourier-transform infrared (FTIR), mass spectrometry, and simple chromatography—provide strong chemical and compositional evidence for authenticity when correlated with reference libraries. These analytic techniques promise rapid, automated risk scoring that scales better than manual inspection. Nevertheless, machine learning and spectral methods face their own limitations in real-world supply chains: acquiring labeled datasets that represent the breadth of legitimate and fraudulent variability is costly and often infeasible, leading to brittle models that suffer from concept drift as agricultural practices, varieties, and adulteration tactics evolve. Models are also susceptible to adversarial manipulation, where an actor intentionally crafts inputs to fool classifiers. Spectral instruments that deliver laboratory-grade fidelity are expensive and require controlled sampling conditions; portable alternatives trade off accuracy for mobility and can produce noisy signals that are challenging to interpret without sophisticated preprocessing and calibration.

Another class of solutions—hybrid digital-certification services provided by third-party certifiers or industry platforms—attempts to blend human auditing with technology. Certification bodies issue verifiable credentials attesting to origin, standards compliance, or organic status, and some platforms combine these credentials with digital tags and stakeholder attestations. While such services leverage established trust frameworks, they remain dependent on the integrity of auditors and auditors’ sampling strategies. Certifications are also periodic and often fail to capture dynamic changes or fraudulent behavior that occurs between audits. Economic incentives further complicate reliance on certification: high verification costs can exclude smallholders from participation, and certification schemes may be gamed through collusion or by focusing checks on a subset of supply chain actors.

Interoperability and standards fragmentation present systemic drawbacks that undermine the cumulative effectiveness of the aforementioned technologies. The diversity of data schemas, identification schemes, communication protocols, and trust models means that integrating across multiple platforms often requires bespoke adapters, manual reconciliation, or data normalization layers that introduce delay and potential error. Regulatory and privacy concerns, especially when sharing data across jurisdictions, further constrain data openness and the ability to pool datasets needed for robust model training. Finally, human factors—actors resistant to change, lack of technical literacy, and competing commercial incentives—impede broad adoption of technically superior systems; technologies that require significant workflow changes or impose perceived surveillance costs will often see limited deployment.

The broad portfolio of technological approaches—automated identification, blockchain anchoring, IoT telemetry, spectral analysis, machine learning, and third-party certification—have each addressed important aspects of provenance and fraud detection in agricultural supply chains, none provides a comprehensive solution that is simultaneously tamper-resistant, scalable, low-cost, privacy-respecting, and robust to adversarial behavior. The persistent gaps relate to data integrity at the source, model generalization and resilience over time, cost and complexity of field-deployable sensing, standards and interoperability, and governance mechanisms that align incentives across diverse stakeholders. Any practical advancement therefore requires careful integration of sensor assurance, cryptographic anchoring, adaptive analytical models, and governance-aware architecture that acknowledges the socio-technical realities of agriculture.

### SUMMARY OF THE INVENTION

The present invention provides a comprehensive system and method for fraud detection and authenticity verification in agricultural supply chains using artificial intelligence. The system integrates a distributed data acquisition infrastructure, an artificial intelligence-based fraud analytics processor, a cryptographic integrity anchoring mechanism, and a structured traceability ledger. The invention further includes a dedicated field authentication device structured as an integrated machine capable of capturing physical, chemical, spectral, and environmental attributes of agricultural commodities and transmitting authenticated datasets for centralized or distributed evaluation.

The system operates by collecting multimodal data including origin metadata, environmental transport parameters, spectral signatures, chemical composition indicators, packaging identifiers, transaction logs, and behavioral patterns of participants in the supply chain. These data streams are harmonized into a standardized digital representation and processed by machine learning models trained to detect anomalies, substitution events, tampering attempts, and authenticity inconsistencies. Cryptographic hashing and distributed ledger anchoring ensure immutability of recorded events, while adaptive learning mechanisms continuously refine fraud detection thresholds based on evolving supply chain patterns.

An object of the present invention is to provide a system and method for fraud detection and authenticity verification in agricultural supply chains using artificial intelligence that enables continuous, end-to-end monitoring of agricultural commodities from point of origin to final distribution, thereby minimizing the risk of product substitution, adulteration, and misrepresentation. The invention seeks to overcome the limitations of fragmented documentation systems by integrating multimodal data sources into a unified, intelligent verification architecture capable of real-time risk assessment and anomaly detection.

Another object of the invention is to establish a tamper-resistant traceability mechanism through the integration of cryptographic hashing and distributed ledger anchoring, ensuring immutability and integrity of recorded supply chain events. The invention aims to create a secure digital audit trail that prevents retroactive data manipulation and provides verifiable provenance evidence to regulators, producers, distributors, and consumers.

A further object of the invention is to incorporate artificial intelligence-based analytical models configured to detect behavioral, transactional, and environmental anomalies across supply chain stages. The invention intends to apply machine learning techniques, including pattern recognition, graph-based analytics, and adaptive anomaly detection algorithms, to generate dynamic fraud risk scores based on deviations from established legitimate operational patterns.

Another object of the invention is to provide a field-deployable authenticity verification device structured as an integrated machine capable of capturing spectral, compositional, visual, and environmental parameters of agricultural commodities. The invention aims to enable on-site validation of product characteristics and immediate comparison against reference authenticity profiles, thereby reducing dependence on centralized laboratory testing and minimizing verification delays.

An additional object of the invention is to ensure interoperability and scalability across heterogeneous supply chain participants by implementing standardized data harmonization and structured digital representation of agricultural batches. The invention seeks to enable seamless integration with existing enterprise systems, regulatory databases, and logistics platforms without compromising security or performance.

Another object of the invention is to provide adaptive learning capability wherein the fraud detection models are continuously updated based on new transactional data, environmental patterns, and detected anomalies, thereby improving predictive accuracy over time and maintaining resilience against evolving fraudulent techniques.

A further object of the invention is to enhance transparency and trust among stakeholders by providing a dynamic authenticity index or fraud risk classification output that is generated through objective, data-driven evaluation rather than subjective inspection alone. The invention seeks to support regulatory compliance, quality assurance, and consumer confidence by providing verifiable and reproducible authenticity assessments.

Another object of the invention is to ensure secure device-level identity and communication integrity through embedded cryptographic security components within the verification machine structure. The invention aims to prevent spoofing, unauthorized data injection, and device cloning, thereby preserving the reliability of measurement data captured at distributed checkpoints.

An additional object of the invention is to provide a robust and portable machine structure capable of operating in diverse agricultural environments, including farms, warehouses, and transportation hubs, while maintaining measurement accuracy under varying environmental conditions. The invention seeks to combine mechanical durability with high-precision sensing capabilities to ensure consistent authenticity verification performance.

A further object of the invention is to reduce economic losses, supply chain inefficiencies, and reputational risks associated with counterfeit or adulterated agricultural products by enabling early detection and automated risk notification mechanisms. The invention aims to facilitate proactive intervention, targeted inspection, and evidence-based decision-making within complex and distributed agricultural ecosystems.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for fraud detection and authenticity verification in agricultural supply chains using artificial intelligence; and

FIG. 2 displays flow chart of a method for fraud detection and authenticity verification in agricultural supply chains using artificial intelligence.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms "comprises", "comprising", or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by "comprises...a" does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

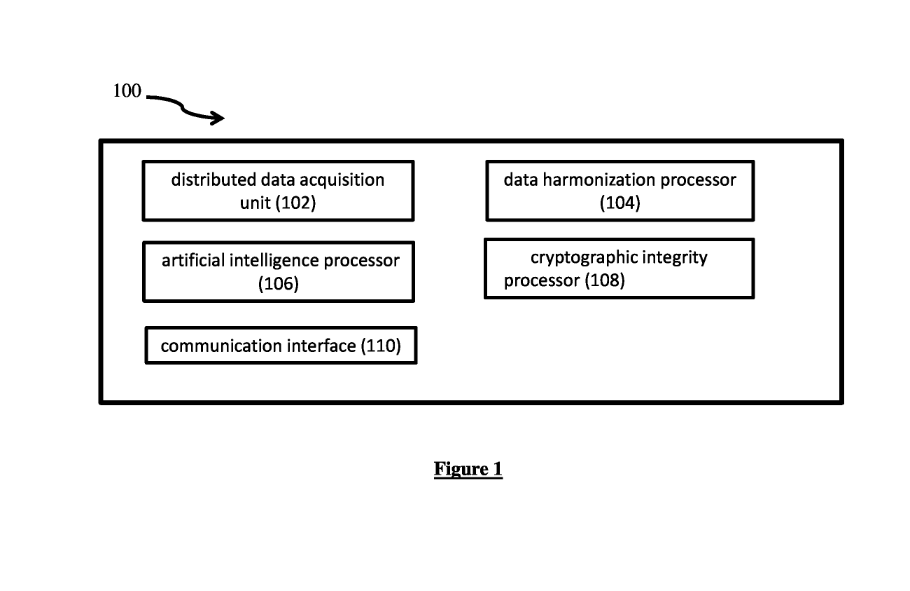

Referring to FIG. 1, a block diagram of a system for fraud detection and authenticity verification in agricultural supply chains using artificial intelligence is illustrated. The system 100 comprising: a distributed data acquisition unit (102) configured to receive multimodal data associated with an agricultural commodity batch from a plurality of supply chain nodes including origin sites, transportation carriers, storage facilities, processing centers, and distribution points; a data harmonization processor (104)operatively connected to the distributed data acquisition unit and configured to transform heterogeneous input data into a normalized structured digital representation comprising interconnected nodes representing custody events and temporal transitions; an artificial intelligence processor (106) configured to analyze the structured digital representation to detect anomalies in transactional behavior, environmental conditions, and participant identity patterns, and to generate a fraud risk score for the agricultural commodity batch; a cryptographic integrity processor (108) configured to generate a unique hash value corresponding to each validated supply chain event and to anchor the hash value into a distributed ledger record; and a communication interface (110)configured to transmit risk classification outputs and authenticity verification results to authorized stakeholder devices.

In an embodiment, the distributed data acquisition unit (102) comprises a plurality of sensor interfaces configured to collect temperature, humidity, vibration, atmospheric composition, geo-spatial coordinates, timestamp metadata, participant identity credentials, and packaging identifier data, and wherein each data packet is digitally signed using a device-level cryptographic key prior to transmission to the data harmonization processor.

In an embodiment, the data harmonization processor (104) is configured to generate a graph-based representation of the agricultural commodity batch in which each node includes metadata fields comprising event timestamp, physical location coordinates, participant identifier, environmental parameter set, and transaction classification, and wherein edges between nodes represent sequential custody transfers validated through digital signature verification.

In an embodiment, the artificial intelligence processor (106) comprises a neural network model trained using historical supply chain trajectories of verified authentic batches, the neural network model being configured to detect deviations in transport duration profiles, environmental parameter distributions, custody frequency patterns, and geographic transition sequences exceeding adaptive threshold criteria derived from statistical baseline modeling.

In an embodiment, the artificial intelligence processor (106) further comprises a graph analysis unit configured to evaluate structural irregularities within the graph-based representation, including circular transaction patterns, abrupt participant substitutions, inconsistent geographic progression, and abnormal transaction density, and to assign weighted anomaly indicators contributing to the fraud risk score.

In an embodiment, further comprising an authenticity comparison processor configured to receive compositional and spectral signature data corresponding to the agricultural commodity batch, compare the received data with stored reference authenticity profiles using similarity evaluation algorithms, and generate an authenticity similarity score that is incorporated into the fraud risk score through weighted aggregation.

In an embodiment, the authenticity comparison processor is configured to process spectral data obtained from near-infrared measurements, visual texture data obtained from high-resolution imaging, and chemical composition markers obtained from sensor analysis, and wherein feature extraction is performed using normalization, noise filtering, and dimensionality reduction prior to similarity computation.

In an embodiment, the cryptographic integrity processor (108) is configured to verify digital signatures of incoming data packets, generate a time-stamped cryptographic hash value for each validated event record, and submit the hash value to a permissioned distributed ledger network for consensus validation, thereby creating an immutable audit record linked to the structured digital representation.

In an embodiment, further comprising a field-deployable authenticity verification device communicatively coupled to the distributed data acquisition unit, the device including a housing structure enclosing an integrated processing unit, a multi-sensor acquisition assembly comprising a spectral sensor, a chemical detection sensor, a high-resolution imaging sensor, and environmental sensors, and a tamper-resistant cryptographic chip configured to generate a unique device identity signature for each measurement event transmitted to the system.

In an embodiment, the integrated processing unit of the field-deployable authenticity verification device is configured to perform local preprocessing including signal calibration, feature extraction, normalization, and encrypted packet generation, and wherein the communication interface is configured to transmit the encrypted packet to the artificial intelligence processor through a secure wireless protocol while temporarily storing measurement logs in a secure memory component during network unavailability, thereby ensuring continuity and integrity of authenticity verification operations.

In an embodiment, the data harmonization processor is configured to perform temporal reconciliation of multimodal data by aligning timestamp metadata received from the plurality of supply chain nodes to a unified coordinated time reference through drift correction based on cryptographically verified time sources, and wherein the data harmonization processor further resolves conflicting custody events by applying precedence rules derived from verified digital signatures and geo-spatial proximity validation such that only chronologically and geographically consistent node sequences are incorporated into the normalized structured digital representation.

In this embodiment, the data harmonization processor executes a deterministic temporal alignment routine that first extracts raw timestamp metadata from each multimodal data packet received from origin sites, transportation carriers, storage facilities, processing centers, and distribution points. Because individual supply chain nodes may rely on independent internal clocks subject to drift, latency, or intentional manipulation, the processor establishes a unified coordinated time reference anchored to a cryptographically verified time source. The verified time source may be derived from a secure network time authority whose responses are digitally signed and validated prior to use. Upon receipt of a data packet, the processor calculates a drift offset by comparing the embedded device timestamp with the cryptographically verified reference time at the moment of receipt and further refines this offset using historical synchronization logs maintained per device identifier. The processor maintains a device-specific drift profile that models systematic deviation patterns over time, enabling correction not only for instantaneous discrepancies but also for gradual clock skew. The corrected timestamp is then assigned to the event record before incorporation into the structured digital representation.

Following timestamp normalization, the processor performs chronological ordering across all custody events associated with the agricultural commodity batch. When two or more events present temporal overlap or sequence inversion after correction, the processor invokes a conflict resolution routine. This routine first validates the digital signatures attached to each event record to confirm data origin authenticity and integrity. Only events with verified digital signatures are considered eligible for precedence evaluation. The processor then computes geo-spatial proximity by analyzing the recorded location coordinates and calculating the physical distance between sequential custody events. If a claimed custody transfer occurs at a location that is physically inconsistent with prior validated coordinates within a feasible transport time window, the processor flags the event as geographically implausible.

Precedence rules are applied based on a combination of signature validity, temporal plausibility, and geo-spatial feasibility. For example, if two custody events claim transfer of the same batch within overlapping time intervals but originate from different participant identifiers, the processor evaluates which event is supported by consistent device signature lineage and realistic travel velocity derived from previous coordinates. Events failing either signature verification or geo-spatial plausibility checks are temporarily isolated and excluded from the main event chain pending further validation. Only those events that satisfy chronological coherence, verified signature authenticity, and spatial feasibility are incorporated into the normalized structured digital representation as interconnected nodes.

This reconciliation process ensures that the graph-based model of the agricultural commodity batch reflects a physically realizable and cryptographically authenticated sequence of custody transitions. By correcting device-level clock drift, preventing temporal spoofing, and eliminating geographically impossible transitions, the system strengthens the reliability of the structured digital representation that serves as the foundation for subsequent anomaly detection and fraud risk computation. The result is a consistent and tamper-resistant event chronology that reduces false anomaly triggers caused by benign clock inconsistencies while simultaneously preventing fraudulent insertion of fabricated or retroactively altered custody records.

In an embodiment, the data harmonization processor is further configured to generate, for each interconnected node, a multi-dimensional event vector comprising environmental statistical descriptors calculated over a sliding time window, transaction frequency metrics computed relative to historical averages for a corresponding participant identifier, and geo-spatial transition parameters derived from successive location coordinates, and wherein the multi-dimensional event vector is appended to the corresponding node prior to analysis by the artificial intelligence processor.

In this embodiment, once chronological consistency and custody validation have been established, the data harmonization processor enriches each interconnected node of the structured digital representation by computing a multi-dimensional event vector that captures contextualized behavioral and environmental characteristics of the agricultural commodity batch. The processor does not rely solely on instantaneous telemetry values; instead, it aggregates environmental sensor readings over a configurable sliding time window associated with each custody interval. Within this window, the processor calculates statistical descriptors including moving averages, rolling variance, peak deviation magnitude, cumulative exposure duration beyond commodity-specific tolerance thresholds, and rate-of-change gradients for parameters such as temperature, humidity, vibration intensity, and atmospheric composition. For example, if a perishable commodity is transported under controlled temperature conditions, the processor evaluates not only whether temperature exceeded a threshold at a single instant but also the duration and slope of deviation over time, thereby distinguishing transient fluctuations from sustained exposure that could indicate tampering or mishandling.

Simultaneously, the processor computes transaction frequency metrics for the participant identifier associated with the node. This computation is performed by retrieving historical custody data linked to the same participant identifier and calculating baseline averages for transfer frequency, average holding duration, and commodity-specific throughput within defined temporal segments such as harvest season or distribution cycle. The processor then derives deviation indices representing how the current transaction frequency compares with the historical baseline for that participant identifier. For instance, if a storage facility historically transfers a batch only after a minimum holding duration of forty-eight hours, but a particular batch is transferred within an unusually short interval, the processor encodes this deviation numerically within the multi-dimensional event vector. This participant-relative normalization ensures that anomaly detection accounts for individual operational patterns rather than applying uniform global thresholds.

In addition to environmental and transactional features, the processor derives geo-spatial transition parameters from successive location coordinates embedded in validated custody events. These parameters include calculated travel distance between nodes, effective transit velocity derived from corrected timestamps, route deviation metrics relative to historically observed corridors, and directional consistency indicators. If the computed velocity exceeds physically plausible transport limits or if the route deviates significantly from established logistical pathways without corresponding justification in transaction metadata, the processor encodes such deviations as quantifiable elements within the event vector. By incorporating spatial dynamics into the node-level representation, the system captures movement-based anomalies that could signal diversion, unauthorized rerouting, or counterfeit substitution.

The resulting multi-dimensional event vector is appended directly to the metadata of the corresponding node within the graph-based representation. This enrichment ensures that each node encapsulates both raw event data and derived contextual analytics prior to analysis by the artificial intelligence processor. By embedding computed statistical descriptors, participant-relative behavioral metrics, and geo-spatial transition parameters into the node structure, the system enhances analytical granularity and reduces the need for repeated preprocessing during downstream risk evaluation. The enriched representation improves detection sensitivity for subtle fraud patterns while maintaining robustness against benign operational variability, thereby enabling more precise and context-aware fraud risk computation.

In an embodiment, the artificial intelligence processor is configured to generate a baseline behavioral profile for each participant identifier by aggregating historical custody events associated with that participant identifier, computing probabilistic transition matrices representing typical source-to-destination movement patterns, and comparing real-time custody transitions of the agricultural commodity batch against the probabilistic transition matrices to identify statistically improbable transfer sequences exceeding adaptive deviation thresholds dynamically recalculated based on cumulative historical variance.

In this embodiment, the artificial intelligence processor constructs a participant-specific behavioral model by continuously aggregating validated historical custody events associated with each participant identifier recorded within the structured digital representation. The aggregation process begins by extracting sequences of source-to-destination custody transitions linked to the participant identifier across multiple agricultural commodity batches and over defined temporal intervals such as harvest cycles or fiscal quarters. Each transition is categorized based on commodity type, geographic region, and transaction classification to ensure contextual relevance. The processor then computes transition frequency distributions that represent how often the participant transfers custody to specific downstream entities under comparable operational conditions.

From these frequency distributions, the processor derives probabilistic transition matrices in which each matrix element represents the conditional probability of a custody transfer from a given source state to a particular destination state. A source state may include the participant identifier combined with contextual attributes such as commodity category and location cluster, while the destination state represents the next validated custody holder within the supply chain graph. These matrices are normalized so that the sum of probabilities for all possible destinations from a given source state equals unity. In addition to first-order transitions, the processor may also compute higher-order transition probabilities that account for short sequences of consecutive events, thereby modeling typical routing patterns across multiple custody steps.

When a real-time custody transition for the agricultural commodity batch is received and validated, the processor retrieves the relevant baseline transition matrix corresponding to the participant identifier and contextual attributes of the event. The observed transition is then mapped to its corresponding probability value within the matrix. If the probability of the observed transition falls below a predefined minimum likelihood threshold, the processor computes a deviation score reflecting the magnitude of departure from established behavioral norms. Rather than relying on static thresholds, the processor dynamically recalculates adaptive deviation thresholds by analyzing cumulative historical variance within the participant’s transition matrix. This recalibration accounts for natural variability in operational routing, seasonal fluctuations, or market-driven changes in distribution channels.

For example, if a grain aggregator historically transfers ninety percent of batches to two designated milling facilities within a specific geographic radius, the transition matrix will reflect high probabilities for those destinations and negligible probabilities for unrelated entities. Should a new batch be transferred to an unfamiliar distribution center in a distant region without corresponding changes in contextual attributes, the calculated probability for that transition would be significantly lower than the baseline range. The processor quantifies this improbability as a statistically significant deviation and incorporates the resulting deviation score into the fraud risk computation.

By modeling participant behavior through probabilistic transition matrices derived from validated historical data and by continuously recalculating deviation thresholds in response to accumulated variance, the system distinguishes between legitimate operational expansion and anomalous transfer sequences indicative of potential diversion or substitution. This participant-specific behavioral modeling enhances the precision of fraud detection by embedding contextual intelligence directly into custody transition analysis and reduces false positives that could arise from applying uniform global routing expectations across diverse supply chain actors.

In an embodiment, the artificial intelligence processor is further configured to perform sequential anomaly detection by encoding temporally ordered nodes of the structured digital representation into a contextual embedding space, generating predicted subsequent event vectors based on preceding node embeddings, and computing a divergence score between predicted event vectors and actual observed event vectors, the divergence score contributing proportionally to the fraud risk score when exceeding a dynamically adjusted tolerance interval.

In this embodiment, the artificial intelligence processor performs sequential anomaly detection by first transforming the temporally ordered nodes of the structured digital representation into contextual embeddings that capture interdependencies among environmental, transactional, identity, and geo-spatial attributes. Each node, already enriched with its multi-dimensional event vector, is mapped into a continuous embedding space through a learned transformation that preserves relational and temporal characteristics of preceding custody events. The transformation parameters are derived from historical sequences of verified authentic batches, allowing the embedding space to represent typical supply chain evolution patterns under legitimate operating conditions.

The processor then constructs ordered sequences of node embeddings corresponding to the chronological progression of the agricultural commodity batch. For each position within the sequence, the processor generates a predicted subsequent event vector based on the embeddings of preceding nodes. This prediction is not based on isolated attributes but on contextual sequence modeling, wherein the processor accounts for cumulative environmental exposure trends, participant transition regularities, and geo-spatial movement continuity. The predicted event vector represents the statistically expected environmental state, transaction characteristics, and identity parameters for the next custody event given the historical trajectory of the batch.

Upon receipt of an actual observed event vector for the subsequent node, the processor computes a divergence score by quantifying the difference between the predicted event vector and the observed event vector. The divergence calculation incorporates element-wise deviation across environmental descriptors, transaction frequency metrics, and geo-spatial transition parameters. The processor applies normalization factors to account for natural variability in each feature dimension and aggregates the deviations into a unified divergence metric. A dynamically adjusted tolerance interval is established based on baseline reconstruction error distributions derived from validated authentic sequences. The tolerance interval is recalibrated periodically to reflect seasonal variation, commodity type differences, and evolving operational patterns.

If the computed divergence score exceeds the current tolerance interval, the processor assigns a proportional contribution to the fraud risk score corresponding to the magnitude and persistence of the deviation. For example, if the predicted event vector anticipates gradual temperature stabilization during refrigerated transport but the observed vector indicates abrupt temperature spikes combined with atypical route deviation, the divergence metric will reflect compounded discrepancies across multiple feature dimensions. The proportional scoring mechanism ensures that minor isolated deviations contribute minimally, whereas sustained or multi-attribute divergence produces a significant elevation in the fraud risk score.

By modeling sequential dependencies rather than evaluating nodes independently, this approach captures temporal inconsistencies that may signal unauthorized diversion, data fabrication, or commodity substitution occurring at intermediate custody stages. The embedding-based prediction and divergence computation enable the system to identify subtle yet structurally meaningful deviations in supply chain progression, thereby enhancing sensitivity to complex fraud patterns while maintaining robustness against benign fluctuations inherent in agricultural logistics.

In an embodiment, the graph analysis unit is configured to compute structural entropy values for subgraphs corresponding to individual agricultural commodity batches, compare the computed structural entropy values with reference entropy ranges derived from verified authentic supply chain graphs, and assign anomaly weights to the fraud risk score when the structural entropy values deviate beyond a statistically defined confidence boundary.

In this embodiment, the graph analysis unit operates directly on the graph-based representation of the agricultural commodity batch after temporal reconciliation and node enrichment have been completed. For each individual batch, the processor isolates a subgraph that includes all validated custody nodes and directed edges representing chronological transfers and process transformations. The graph analysis unit then derives structural descriptors from this subgraph, including node degree distributions, edge density, path length distributions, branching factors, and recurrence patterns across participant identifiers. Using these descriptors, the unit computes a structural entropy value that quantifies the level of disorder or unpredictability in the connectivity structure of the batch-specific subgraph.

The structural entropy calculation is performed by first determining the probability distribution of node transition frequencies and connectivity patterns within the subgraph. For example, the processor evaluates how evenly custody transitions are distributed among downstream participants, how frequently branching occurs from a single node, and whether repetitive cycles exist among a limited set of participants. From this distribution, an entropy measure is derived that reflects whether the custody flow exhibits stable, predictable progression or irregular, highly diversified connectivity. A linear, well-structured supply chain typically produces entropy values within a narrow range because custody transfers follow established operational pathways. In contrast, irregular patterns such as circular trading loops, sudden branching to unfamiliar entities, or repeated short-interval reassignments produce entropy deviations.

To determine acceptable variability, the graph analysis unit maintains reference entropy ranges derived from a corpus of verified authentic supply chain graphs corresponding to similar commodity types, geographic contexts, and seasonal conditions. These reference ranges are computed using statistical aggregation of entropy values from authenticated batches and include confidence boundaries that account for legitimate operational diversity. When a new batch subgraph is analyzed, the computed structural entropy value is compared against the relevant reference range selected based on contextual metadata from the structured digital representation.

If the structural entropy value exceeds or falls below the statistically defined confidence boundary, the graph analysis unit calculates an anomaly weight proportional to the magnitude of deviation. For example, a significantly lower entropy value might indicate a repetitive closed-loop transfer pattern among a limited set of participants, suggesting potential collusive activity. Conversely, an unusually high entropy value might reflect chaotic routing inconsistent with typical distribution channels, potentially indicating diversion or unauthorized re-routing. The calculated anomaly weight is integrated into the overall fraud risk score in conjunction with other behavioral and compositional indicators.

By quantifying structural irregularities at the graph level rather than relying solely on node-level attributes, this embodiment captures higher-order relational anomalies that emerge from collective custody patterns. The entropy-based assessment enhances detection of coordinated fraud schemes involving multiple actors and prevents evasion strategies that attempt to manipulate individual transaction attributes while preserving superficially valid local event data. The result is a more resilient fraud detection mechanism that evaluates the integrity of the entire custody topology associated with an agricultural commodity batch.

In an embodiment, the authenticity comparison processor is configured to construct a reference authenticity profile library indexed by commodity type, geographic origin, harvest season, and processing classification, and wherein the processor selects a subset of reference profiles based on metadata contained within the structured digital representation prior to performing similarity evaluation, thereby restricting comparison to contextually relevant authenticity baselines.

In this embodiment, the authenticity comparison processor maintains a dynamically expandable reference authenticity profile library derived from laboratory-verified and field-validated agricultural commodity samples. Each reference profile stored in the library contains calibrated spectral signatures, compositional marker distributions, and visual texture descriptors captured under standardized measurement conditions. During library construction, samples are categorized and indexed according to commodity type, certified geographic origin, harvest season, and processing classification, such as raw, dried, milled, fermented, or refined. These indices are encoded as structured metadata fields that allow deterministic retrieval of contextually relevant reference sets.

When a new agricultural commodity batch is evaluated, the processor extracts contextual metadata from the structured digital representation generated by the data harmonization processor. This metadata includes declared commodity type, origin coordinates, seasonal harvest timestamp, and recorded processing stage transitions. Using these attributes as query parameters, the processor retrieves a subset of reference authenticity profiles that match the contextual parameters within predefined tolerance ranges. For example, if the batch is identified as a spice harvested during a specific seasonal window from a defined geographic cluster and subsequently processed through drying, the processor selects only those reference profiles corresponding to the same commodity species, comparable origin coordinates, similar harvest season intervals, and equivalent processing classification. This contextual filtering avoids cross-comparison with unrelated profiles that could exhibit natural compositional variation due to climate, soil conditions, or processing techniques.

After subset selection, the processor performs similarity evaluation exclusively against the retrieved reference profiles. By limiting the comparison domain to contextually aligned baselines, the system reduces false deviations that might otherwise arise from legitimate regional or seasonal variability. The processor further computes distributional envelopes for the selected subset, establishing acceptable compositional and spectral variability bands derived from authentic samples within that context. Similarity scores for the batch under analysis are calculated relative to these localized baselines rather than against a global aggregate profile.

For example, two agricultural batches of the same commodity species but from different geographic regions may naturally differ in minor spectral characteristics due to soil mineral composition. By indexing the reference library with origin-specific metadata and selecting only regionally aligned profiles, the processor ensures that authenticity evaluation reflects expected local variability rather than treating natural differences as anomalies. Similarly, seasonal moisture content variations are accounted for by restricting comparison to harvest-season-matched profiles.

Through contextual indexing and targeted subset selection, this embodiment enhances discrimination accuracy by aligning authenticity evaluation with the intrinsic variability parameters of the commodity. It minimizes misclassification caused by environmental diversity while strengthening the system’s ability to detect true substitution or adulteration events that deviate from legitimate contextual baselines.

In an embodiment, the authenticity comparison processor is further configured to apply adaptive spectral calibration by compensating received spectral data for ambient temperature and humidity values recorded by the distributed data acquisition unit, adjusting baseline offsets using calibration coefficients stored in association with the spectral sensor, and generating a corrected spectral feature vector prior to dimensionality reduction and similarity computation.

In this embodiment, the authenticity comparison processor performs adaptive spectral calibration to ensure that the spectral signature used for authenticity evaluation reflects intrinsic material characteristics rather than environmental measurement distortions. When spectral data are received from the field-deployable authenticity verification device, the processor simultaneously retrieves ambient temperature and humidity values recorded by the distributed data acquisition unit at the time of measurement. These environmental parameters are associated with known influences on spectral reflectance and absorbance characteristics, particularly in near-infrared measurements where moisture content and thermal fluctuations can alter baseline intensity and peak distribution.

The processor first identifies the spectral sensor profile linked to the incoming data packet and retrieves calibration coefficients stored in association with that specific sensor identifier. These calibration coefficients are generated during periodic calibration procedures performed under standardized environmental conditions and are securely stored within the system database. The processor applies compensation factors derived from the recorded ambient temperature and humidity values to correct baseline drift and wavelength-specific intensity shifts. For example, if elevated humidity levels are known to amplify absorption peaks within certain wavelength bands due to water vapor interaction, the processor proportionally adjusts the affected spectral intensities based on the recorded humidity reading and the corresponding calibration coefficient curve.

In addition to environmental compensation, the processor performs baseline offset correction by subtracting reference dark current values and normalizing signal intensity relative to calibration standards stored for that sensor. This ensures that sensor aging effects, minor hardware drift, or ambient light interference do not propagate into the authenticity similarity evaluation. The corrected spectral data are then converted into a standardized spectral feature vector through normalization procedures that align amplitude scales across measurements and remove non-informative background components.

Prior to similarity computation, the processor may apply dimensionality reduction to the corrected spectral feature vector to isolate informative wavelength bands while minimizing redundant or noise-prone dimensions. Because calibration has already accounted for environmental and hardware variability, the resulting reduced feature vector preserves discriminative compositional characteristics intrinsic to the agricultural commodity sample. For example, when evaluating a batch of grains transported under fluctuating warehouse humidity conditions, adaptive calibration ensures that spectral variations caused by ambient moisture are neutralized, allowing the similarity evaluation to focus on genuine compositional markers rather than transient environmental artifacts.

By integrating environmental compensation and sensor-specific baseline adjustment into the preprocessing workflow, this embodiment enhances the stability and reproducibility of spectral comparisons across distributed field conditions. The corrected spectral feature vector provides a consistent and context-neutral input for authenticity similarity computation, thereby improving detection reliability and reducing both false positives and false negatives associated with environmental measurement variability.

In an embodiment, the authenticity similarity score is computed by aggregating multiple similarity measures derived independently from spectral features, visual texture descriptors, and chemical composition markers, and wherein weighting coefficients applied to the multiple similarity measures are dynamically adjusted based on a reliability index calculated from signal-to-noise ratios and calibration status of the multi-sensor acquisition assembly.

In this embodiment, the authenticity comparison processor computes the authenticity similarity score through a multi-channel evaluation process in which independent similarity measures are generated from spectral features, visual texture descriptors, and chemical composition markers captured by the multi-sensor acquisition assembly. Each sensing channel produces a feature vector derived through prior preprocessing steps, including calibration, normalization, and noise filtering. The processor calculates a first similarity measure by comparing the corrected spectral feature vector with contextually selected reference spectral profiles using distance-based and correlation-based evaluation metrics. A second similarity measure is derived by extracting visual texture descriptors from high-resolution images of the agricultural commodity, including spatial frequency distributions, granularity patterns, and morphological consistency parameters, and comparing these descriptors with corresponding reference image feature sets. A third similarity measure is generated by analyzing chemical composition markers detected by the chemical sensor, such as concentration distributions of characteristic compounds, and comparing these distributions against statistically defined ranges in the reference authenticity profile library.

Each similarity measure is normalized onto a common scale to allow meaningful aggregation across heterogeneous modalities. However, rather than assigning fixed weighting coefficients to each modality, the processor computes a reliability index for each sensor channel prior to aggregation. The reliability index is determined by evaluating the signal-to-noise ratio of the acquired measurement, which is computed by comparing the amplitude of informative signal components against background noise levels detected during calibration. In addition, the processor retrieves the most recent calibration status associated with each sensor, including calibration timestamp, deviation from baseline reference standards, and any detected sensor drift indicators. If a sensor exhibits degraded signal integrity or is operating near the limits of acceptable calibration tolerance, its corresponding reliability index is proportionally reduced.

The weighting coefficients applied to each similarity measure are then dynamically adjusted in accordance with the computed reliability indices. For example, if the spectral sensor exhibits a high signal-to-noise ratio and recent calibration confirmation, while the imaging sensor indicates reduced lighting uniformity or minor calibration drift, the processor assigns a higher weight to the spectral similarity measure and a lower weight to the visual texture similarity measure in the aggregated authenticity similarity score. Conversely, if the chemical composition sensor records unstable readings due to environmental interference, its influence on the final score is attenuated.

The aggregated authenticity similarity score is calculated by combining the normalized similarity measures using the dynamically adjusted weighting coefficients, ensuring that more reliable data sources exert proportionally greater influence on the final determination. This adaptive aggregation process reduces susceptibility to single-sensor anomalies and prevents distorted authenticity evaluations caused by temporary degradation in any individual sensing modality. By incorporating sensor reliability assessment directly into the scoring algorithm, the system achieves a balanced and resilient authenticity evaluation that remains robust across variable field conditions and heterogeneous measurement environments.

In an embodiment, the cryptographic integrity processor is configured to compute the time-stamped cryptographic hash value over a canonical serialized representation of each validated supply chain event including node metadata, multi-dimensional event vectors, and authenticity similarity scores, and wherein the canonical serialized representation is deterministically ordered to ensure identical hash generation across distributed verification instances.

In this embodiment, the cryptographic integrity processor generates a tamper-evident fingerprint for every validated supply chain event by first constructing a canonical serialized representation of the event data. The processor aggregates all relevant elements associated with a specific node in the structured digital representation, including node metadata fields such as corrected timestamp, geo-spatial coordinates, participant identifier, transaction classification, and validated digital signature references. In addition, the processor incorporates the computed multi-dimensional event vector appended during data harmonization, as well as the authenticity similarity scores and associated reliability indicators generated by the authenticity comparison processor. Rather than hashing raw database records in arbitrary order, the processor converts the event data into a deterministic serialized format in which each field is arranged in a predefined sequence with standardized encoding rules.

The canonical serialization process enforces strict ordering of attributes to eliminate ambiguity across distributed verification environments. For example, metadata fields are sorted lexicographically by field identifier, numerical values are encoded using fixed precision and consistent byte ordering, and nested structures such as event vectors are serialized according to a predefined index order corresponding to their feature dimensions. Any optional or null fields are explicitly represented using standardized placeholders to prevent omission-based variation. This deterministic ordering ensures that independent verification nodes reconstructing the same event record will produce identical serialized outputs, thereby yielding identical hash values when applying the cryptographic hash function.

Once the canonical serialized representation is generated, the cryptographic integrity processor computes a time-stamped hash value by applying a secure cryptographic hashing algorithm to the serialized byte stream concatenated with a validated time reference. The timestamp incorporated into the hash is derived from the unified coordinated time reference previously established by the data harmonization processor, ensuring consistency and resistance to local clock manipulation. The resulting hash value uniquely represents the exact content and structure of the validated event at that point in time.

This approach prevents inconsistencies that could arise if distributed verification instances applied different serialization orders or encoding conventions. By standardizing the canonical serialization procedure and including all relevant analytical outputs within the hash computation, the system ensures that any modification to node metadata, environmental descriptors, authenticity scores, or event vectors will produce a different hash value upon recalculation. Consequently, any attempt to alter historical supply chain data, recompute risk scores, or manipulate authenticity outcomes without corresponding ledger updates becomes immediately detectable through hash mismatch verification. The deterministic serialization and hashing mechanism provides consistent cross-node verification capability while maintaining strict integrity control over analytical and transactional event records within the agricultural supply chain.

In an embodiment, the cryptographic integrity processor is further configured to perform periodic integrity audits by recalculating hash values from stored structured digital representations, retrieving corresponding anchored hash values from the distributed ledger record, and identifying discrepancies through hash comparison, and wherein identified discrepancies trigger generation of a tamper alert transmitted through the communication interface.

In this embodiment, the cryptographic integrity processor executes a scheduled integrity verification routine to ensure that the stored structured digital representations of agricultural commodity batches remain consistent with the immutable records anchored in the distributed ledger. At predetermined audit intervals or upon detection of specific risk conditions, the processor retrieves previously validated supply chain event records from the system database. For each event, the processor reconstructs the canonical serialized representation using the same deterministic ordering rules applied during the original hash generation, including node metadata, appended multi-dimensional event vectors, authenticity similarity scores, and associated timestamp values derived from the unified coordinated time reference.

The processor then recalculates a new hash value over the reconstructed canonical serialized representation. Concurrently, it retrieves the corresponding anchored hash value previously submitted to and stored within the distributed ledger record. The retrieval is performed through a secure query mechanism that validates ledger node authenticity and confirms that the referenced record corresponds to the correct event identifier and timestamp sequence. Once both the recalculated hash value and the anchored hash value are available, the processor performs a direct comparison to determine consistency.

If the recalculated hash value matches the anchored hash value, the integrity of the stored event data is confirmed. If a discrepancy is detected, indicating that the stored representation has been altered, corrupted, or partially modified after initial anchoring, the processor identifies the specific event record associated with the mismatch. The processor may further perform differential analysis by isolating fields within the reconstructed serialization to determine whether the discrepancy originated from metadata modification, event vector alteration, or authenticity score tampering. Upon detection of any inconsistency, the processor generates a tamper alert containing the affected event identifier, timestamp, participant identifiers involved, and the nature of the detected inconsistency.

The tamper alert is transmitted through the communication interface as a digitally signed notification to authorized stakeholder devices and supervisory entities. The alert packet includes verifiable references to the original anchored ledger entry, enabling independent validation by recipients. This periodic integrity audit mechanism ensures that post-anchoring modifications, whether malicious or accidental, are detected promptly. By continuously validating stored records against immutable ledger references, the system maintains persistent data integrity across distributed storage environments and prevents undetected manipulation of historical supply chain events or analytical outputs associated with agricultural commodity batches.

In an embodiment, the integrated processing unit of the field-deployable authenticity verification device is configured to perform real-time feature extraction by applying digital filtering to remove high-frequency noise components from raw sensor signals, executing baseline normalization using calibration reference measurements stored within the secure memory component, and generating a compact feature representation suitable for encrypted transmission to the artificial intelligence processor.

In this embodiment, the integrated processing unit within the field-deployable authenticity verification device performs on-device signal conditioning and feature generation prior to any external transmission, thereby ensuring that only analytically meaningful and integrity-verified data are forwarded to the central system. Upon acquisition of raw sensor signals from the spectral sensor, chemical detection sensor, high-resolution imaging sensor, and associated environmental sensors, the integrated processing unit first converts the analog signals into digitized form using calibrated sampling parameters synchronized with the device’s internal clock. The digitized signals may contain high-frequency noise components resulting from ambient electrical interference, mechanical vibration, or sensor circuit fluctuations. To mitigate these artifacts, the processing unit applies digital filtering techniques implemented in firmware, including frequency-domain filtering and time-domain smoothing operations that selectively attenuate non-informative high-frequency components while preserving characteristic signal peaks and feature transitions associated with the agricultural commodity under examination.

Following noise attenuation, the integrated processing unit executes baseline normalization routines using calibration reference measurements stored within the secure memory component of the device. These calibration references are generated during controlled calibration procedures and represent standardized response curves for the sensors under known environmental and material conditions. The processing unit compares the filtered signal with the stored baseline references and applies offset correction factors to compensate for sensor drift, minor hardware aging effects, or ambient lighting variability in the case of imaging data. For spectral signals, baseline normalization includes intensity scaling and correction for dark current offsets, ensuring that the signal amplitude distribution aligns with expected operational ranges. For chemical composition signals, normalization adjusts measured concentration responses relative to stored calibration curves to maintain quantitative consistency across repeated measurements.

After filtering and normalization, the integrated processing unit performs feature extraction to convert high-resolution raw signals into a compact feature representation. In the case of spectral data, informative wavelength bands are selected and encoded as amplitude or derivative features that capture compositional characteristics. For image-based data, spatial texture descriptors and morphological parameters are computed from the processed image frame. For chemical sensor readings, concentration ratios and compound-specific response magnitudes are calculated. These features are structured into a standardized feature vector format that balances informational richness with transmission efficiency.

The resulting compact feature representation is then encapsulated into a secure data packet that includes device identification metadata and a measurement timestamp. The packet is encrypted using cryptographic credentials stored in the tamper-resistant security component before transmission through the communication interface to the artificial intelligence processor. By performing real-time filtering, normalization, and feature extraction at the device level, the system reduces transmission bandwidth requirements, minimizes exposure of raw sensor data to interception, and ensures that the artificial intelligence processor receives consistent, preconditioned feature vectors optimized for reliable authenticity analysis under diverse field conditions.

In an embodiment, the tamper-resistant cryptographic chip is configured to generate a device identity signature by computing a cryptographic digest over the extracted feature representation and a device-unique private key stored within a secure enclave, and wherein the generated device identity signature is verified by the cryptographic integrity processor prior to acceptance of compositional and spectral signature data for authenticity comparison.

In this embodiment, the tamper-resistant cryptographic chip embedded within the field-deployable authenticity verification device operates as a hardware-rooted trust anchor that binds each measurement event to a uniquely identifiable and non-exportable device credential. Upon completion of real-time feature extraction by the integrated processing unit, the compact feature representation, together with associated metadata such as corrected timestamp and sensor identifiers, is transmitted internally to the cryptographic chip through a secure hardware bus. The cryptographic chip resides within a secure enclave that prevents external access to its internal memory and cryptographic material, thereby ensuring that the device-unique private key cannot be read, copied, or altered through software-level intrusion.

The cryptographic chip computes a cryptographic digest over the extracted feature representation using a secure hashing function implemented in hardware. This digest uniquely represents the measurement content in a fixed-length format. The chip then applies a digital signature operation by encrypting the digest with the device-unique private key stored exclusively within the secure enclave. The private key is generated during device provisioning and is mathematically linked to a corresponding public key registered within the central system at deployment time. Because the private key never leaves the secure enclave and is protected against physical probing and side-channel extraction, the resulting device identity signature cryptographically binds the measurement data to the specific physical device that generated it.

The signed data packet, comprising the extracted feature representation, associated metadata, and the device identity signature, is transmitted via the communication interface to the central system. Upon receipt, the cryptographic integrity processor retrieves the registered public key corresponding to the device identifier included in the packet. The processor independently recomputes the cryptographic digest over the received feature representation and verifies the digital signature using the public key. If the verification process confirms that the signature corresponds to the registered device and that the content has not been altered in transit, the compositional and spectral signature data are accepted for further authenticity comparison processing. If the verification fails, the data packet is rejected and flagged as potentially tampered or originating from an unauthorized device.

By requiring hardware-based signature generation tied to a secure enclave and enforcing signature verification prior to analytical processing, the system ensures that authenticity evaluations are performed only on trusted measurement data. This approach prevents spoofed sensor outputs, unauthorized device cloning, and replay attacks involving previously captured measurement data. The integration of device-bound cryptographic signing into the authenticity workflow establishes a verifiable chain of custody at the measurement level, strengthening overall system resilience against fraudulent data injection within agricultural supply chain verification processes.

In an embodiment, the artificial intelligence processor is configured to update adaptive threshold criteria by periodically recalculating statistical baseline parameters using newly validated structured digital representations and confirmed fraud instances, adjusting weighting coefficients of anomaly indicators through iterative optimization based on misclassification error minimization, and applying the updated threshold criteria to subsequent fraud risk score computations without interrupting ongoing data acquisition.

In this embodiment, the artificial intelligence processor incorporates a continuous learning mechanism that refines fraud detection sensitivity by periodically recalculating statistical baseline parameters using newly validated structured digital representations and confirmed fraud instances accumulated within the system. The processor maintains a segregated training repository containing supply chain graphs, multi-dimensional event vectors, authenticity similarity scores, and final verification outcomes categorized as verified authentic or confirmed fraudulent. At predefined intervals or upon accumulation of sufficient new validated records, the processor initiates a recalibration cycle in which updated distributions of environmental descriptors, transaction frequency metrics, geo-spatial transition parameters, and structural entropy values are computed. These updated distributions are used to redefine statistical baselines that represent legitimate operational variability across commodity types, participant identifiers, geographic regions, and seasonal contexts.

During recalibration, adaptive deviation thresholds associated with anomaly indicators are recomputed by analyzing cumulative variance and distributional shifts observed in the expanded dataset. For example, if legitimate supply chain expansion introduces new routing pathways that were previously rare, the recalculated baseline transition probabilities are adjusted to reflect this broader operational diversity. Conversely, if newly confirmed fraud cases reveal recurring anomaly patterns such as specific route deviations or abrupt custody frequency spikes, the processor adjusts sensitivity parameters to increase detection responsiveness for those patterns. This recalibration ensures that anomaly thresholds remain aligned with evolving supply chain behaviors while preserving discrimination capability against fraudulent activity.

In addition to recalculating baselines, the processor performs iterative optimization of weighting coefficients applied to different anomaly indicators during fraud risk score aggregation. The optimization process evaluates historical classification outcomes by comparing predicted fraud risk scores against confirmed ground-truth labels. Misclassification errors, including false positives and false negatives, are quantified, and gradient-based adjustment routines are applied to refine weighting coefficients in a manner that minimizes aggregate error across validation datasets. The optimization routine operates on stored data snapshots and does not interfere with real-time inference pipelines. Updated weighting parameters are stored in a version-controlled configuration structure that allows traceable deployment into the active fraud risk computation workflow.

To prevent disruption of ongoing data acquisition and real-time analysis, recalibration and optimization processes are executed in parallel to operational processing threads. Once updated thresholds and weighting coefficients are validated against holdout validation sets to confirm stability, they are seamlessly integrated into the live fraud risk computation environment. The integration is performed through parameter substitution without requiring system downtime or interruption of event ingestion from distributed data acquisition units.

Through this adaptive update mechanism, the artificial intelligence processor maintains alignment with dynamic supply chain conditions, seasonal variability, and emerging fraud tactics. Continuous recalibration based on validated outcomes enhances classification accuracy over time, reduces drift-induced degradation in anomaly detection performance, and sustains reliable fraud risk scoring across long-term system operation within agricultural supply chain environments.

In an embodiment, the communication interface is configured to transmit the fraud risk score, authenticity similarity score, and integrity validation status as a composite authenticity index embedded within a digitally signed response packet, and wherein the digitally signed response packet includes a verifiable reference to the anchored distributed ledger record corresponding to the agricultural commodity batch, such that authorized stakeholder devices can independently validate the authenticity index against the distributed ledger record and the associated structured digital representation.

In this embodiment, the communication interface operates as a secure dissemination layer that packages analytical outcomes into a verifiable and tamper-evident response structure prior to transmission to authorized stakeholder devices. After completion of fraud risk computation, authenticity similarity evaluation, and integrity verification, the system generates a composite authenticity index derived from weighted aggregation of the fraud risk score, the context-adjusted authenticity similarity score, and the ledger integrity validation status. Rather than transmitting these values independently, the processor encodes them into a structured response payload that includes batch identifier metadata, timestamp synchronized to the unified coordinated time reference, and a reference pointer corresponding to the specific distributed ledger record in which the validated event hashes are anchored.

The communication interface constructs a digitally signed response packet by first serializing the composite authenticity index and associated metadata into a deterministic format consistent with internal canonical encoding rules. A cryptographic digest of the serialized payload is computed and signed using a system-level private key stored within a secure execution environment of the central infrastructure. The resulting digital signature is appended to the packet along with the public key certificate chain necessary for external verification. The response packet also includes the ledger record reference, which may consist of a ledger transaction identifier, block reference, or hash pointer that uniquely corresponds to the anchored record for the agricultural commodity batch.

Upon receipt of the digitally signed response packet, an authorized stakeholder device, such as a regulatory authority terminal, distributor verification terminal, or retail authentication application, performs independent signature verification using the system’s public key. The stakeholder device then retrieves the referenced distributed ledger record using the included ledger pointer and validates that the anchored hash corresponds to the canonical serialized representation of the event data associated with the batch. This independent validation process allows the stakeholder device to confirm that the composite authenticity index has been derived from ledger-anchored and integrity-verified data without relying solely on the central processing system’s assertion.

For example, a distributor receiving a shipment can query the ledger reference included in the response packet, reconstruct the canonical representation from locally cached structured digital representation data, compute a verification hash, and compare it to the anchored ledger value. If the values match and the digital signature is valid, the distributor can confirm both the authenticity index and the integrity of the underlying event chain. This dual-layer verification mechanism ensures transparency and trust propagation across the supply chain ecosystem.

By embedding analytical outputs within a digitally signed response packet that includes verifiable ledger references, the communication interface enables decentralized authenticity validation while preserving centralized analytical computation. This architecture prevents unauthorized alteration of authenticity results during transmission, supports independent cross-verification by stakeholders, and strengthens confidence in fraud detection outcomes across distributed agricultural supply chain networks.

The distributed data acquisition unit is implemented as a physical hardware assembly comprising network interface circuitry, sensor input ports, embedded microcontrollers, and secure memory modules configured to receive and temporarily buffer multimodal data from external sensing devices and supply chain terminals. The data harmonization processor is realized as a dedicated processing circuit or server-grade computing hardware including one or more central processing units, volatile and non-volatile memory, and persistent storage media configured to execute deterministic synchronization, normalization, and graph-construction instructions stored in machine-readable form. The artificial intelligence processor is embodied as a high-performance computing subsystem comprising multi-core processors and hardware acceleration circuitry capable of executing numerical computation routines for feature encoding, probabilistic modeling, sequential prediction, and anomaly scoring, the subsystem being physically integrated with memory resources sufficient to store historical training datasets and updated model parameters. The authenticity comparison processor is implemented as a specialized computing unit or co-processor configured to receive calibrated spectral, image, and chemical feature inputs and perform similarity computations using dedicated arithmetic logic circuitry and high-speed memory buffers. The cryptographic integrity processor is embodied as a secure hardware-based cryptographic module containing a protected execution environment, hardware random number generation circuitry, and secure key storage elements configured to compute cryptographic digests, generate digital signatures, and interface with distributed ledger nodes through encrypted communication channels. The communication interface is implemented as a physical transceiver assembly including wired and wireless communication controllers, antenna structures where applicable, encryption circuitry, and protocol-handling firmware enabling secure packet formation, digital signing, and network transmission. The field-deployable authenticity verification device is a tangible machine comprising a rigid housing structure, printed circuit boards mounting the integrated processing unit, multi-sensor acquisition assembly including optical sensing elements, chemical sensing electrodes, imaging sensors, and environmental sensing components, along with analog-to-digital converters, signal conditioning circuits, and embedded firmware stored in non-volatile memory. The integrated processing unit within the device consists of a microprocessor or system-on-chip physically mounted on the circuit board, electrically connected to the sensors and secure memory, and configured to execute filtering, normalization, and feature extraction routines in real time. The tamper-resistant cryptographic chip is a discrete hardware security element embedded within the device, containing a physically isolated secure enclave, non-exportable private key storage, and cryptographic acceleration circuitry that performs signing operations internally without exposing secret material to external buses. Each of these components is implemented using physical electronic circuitry interconnected through conductive traces and communication buses, thereby forming a fully realized hardware architecture capable of executing the described data acquisition, processing, authentication, cryptographic verification, and communication operations within an agricultural supply chain environment.

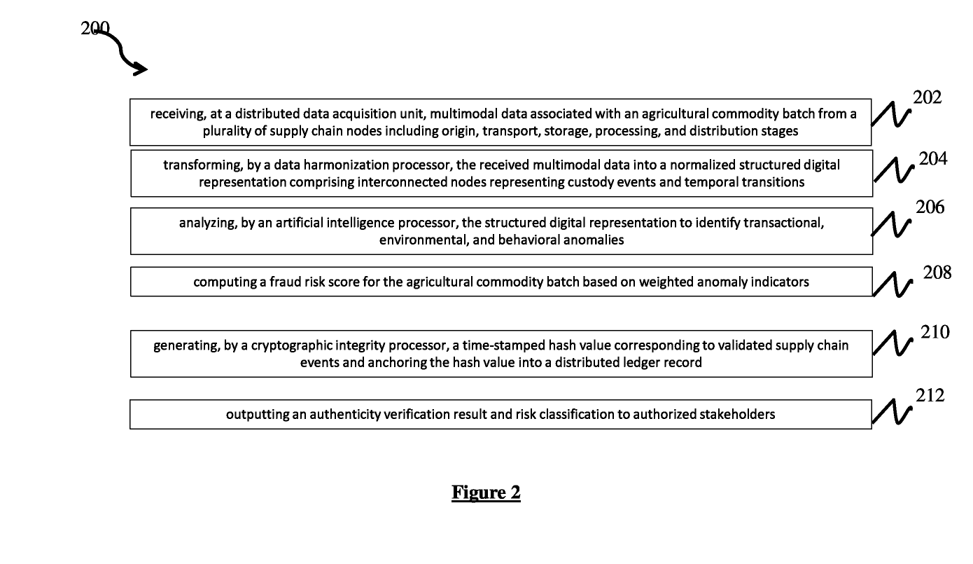

Referring to FIG. 2, a flow chart of a method for fraud detection and authenticity verification in agricultural supply chains using artificial intelligence, comprising the steps of, the method is illustrated. The method 200 comprising:

At step 202, the method 200 includes receiving, at a distributed data acquisition unit, multimodal data associated with an agricultural commodity batch from a plurality of supply chain nodes including origin, transport, storage, processing, and distribution stages;

At step 204, the method 200 includes transforming, by a data harmonization processor, the received multimodal data into a normalized structured digital representation comprising interconnected nodes representing custody events and temporal transitions;

At step 206, the method 200 includes analyzing, by an artificial intelligence processor, the structured digital representation to identify transactional, environmental, and behavioral anomalies;

At step 208, the method 200 includes computing a fraud risk score for the agricultural commodity batch based on weighted anomaly indicators;

At step 210, the method 200 includes generating, by a cryptographic integrity processor, a time-stamped hash value corresponding to validated supply chain events and anchoring the hash value into a distributed ledger record; and

At step 212, the method 200 includes outputting an authenticity verification result and risk classification to authorized stakeholders.

In an embodiment, receiving multimodal data comprises acquiring environmental parameters including temperature, humidity, vibration, and atmospheric composition, acquiring geo-spatial coordinates and timestamp metadata, acquiring participant identity credentials and packaging identifiers, and digitally signing each data packet using a device-level cryptographic key prior to processing.

In an embodiment, transforming the received multimodal data into the normalized structured digital representation comprises generating a graph-based representation in which each node includes metadata fields comprising event timestamp, physical location coordinates, participant identifier, environmental parameter set, and transaction classification, and linking nodes through edges representing validated custody transfers.

In an embodiment, analyzing the structured digital representation comprises applying a neural network model trained on historical verified supply chain trajectories to detect deviations in transport duration, environmental parameter distribution, custody transfer frequency, and geographic progression patterns exceeding adaptive threshold values derived from baseline statistical modeling.

In an embodiment, analyzing further comprises evaluating structural irregularities in the graph-based representation including circular transaction sequences, abrupt participant substitutions, inconsistent geographic transitions, and abnormal transaction density, and assigning weighted anomaly indicators contributing to the fraud risk score.

In an embodiment, further comprising receiving compositional and spectral signature data corresponding to the agricultural commodity batch from a field-deployable authenticity verification device, extracting features through calibration, normalization, and noise filtering, comparing the extracted features with stored reference authenticity profiles using similarity evaluation algorithms, and generating an authenticity similarity score incorporated into the fraud risk score.

In an embodiment, comparing the extracted features with stored reference authenticity profiles comprises processing near-infrared spectral data, high-resolution image texture data, and chemical composition markers, and computing similarity metrics to determine deviation from reference authenticity baselines.

In an embodiment, generating the time-stamped hash value comprises verifying digital signatures of incoming data packets, generating a cryptographic hash corresponding to each validated supply chain event, and submitting the hash to a permissioned distributed ledger network for consensus validation to create an immutable audit record.

In an embodiment, further comprising dynamically updating the artificial intelligence processor by retraining anomaly detection models using newly validated supply chain data and confirmed fraud instances to refine threshold parameters and improve predictive accuracy over time.

In an embodiment, further comprising generating a dynamic authenticity index based on weighted aggregation of the fraud risk score, authenticity similarity score, environmental deviation magnitude, and participant identity consistency indicators, and transmitting automated alert notifications to regulatory or supervisory entities when the dynamic authenticity index exceeds a predefined risk threshold.

The present invention implements a multi-layered computational architecture for fraud detection and authenticity verification in agricultural supply chains using artificial intelligence, wherein the algorithmic workflow is designed to ingest heterogeneous data streams, convert the data into a structured digital representation, perform multi-dimensional anomaly detection, compute authenticity similarity measures, generate a composite fraud risk score, and anchor validated records into a cryptographically secure ledger. The detailed description below elaborates the algorithmic and processing mechanisms underlying the claimed system and method.

At the initial stage, the distributed data acquisition unit collects multimodal data from multiple supply chain nodes. Each agricultural commodity batch is assigned a persistent digital identifier at the point of origin. Incoming data streams include environmental telemetry such as temperature, humidity, vibration intensity, atmospheric gas composition, and geo-spatial coordinates; transactional data such as custody transfers, batch aggregation or splitting events, and processing transformations; and identity data including participant credentials and device authentication signatures. Each data packet is digitally signed at the device level using a cryptographic key embedded in a secure hardware element. Upon receipt, the system verifies the digital signature to ensure source authenticity and rejects packets failing signature validation.

The data harmonization processor transforms heterogeneous inputs into a normalized representation. This transformation includes timestamp synchronization, unit standardization, missing value handling, and semantic mapping of participant identifiers into canonical identity structures. The processor then constructs a graph-based digital twin of the agricultural commodity batch. In this graph representation, each node corresponds to a discrete supply chain event characterized by attributes including event timestamp, location coordinates, environmental parameter vector, participant identifier, and transaction classification. Directed edges connect nodes to represent custody transitions or process transformations. Temporal ordering constraints are enforced to ensure that subsequent nodes reflect valid chronological progression. The graph is stored in a structured memory format enabling efficient traversal and feature extraction.

Feature extraction is performed prior to artificial intelligence analysis. From the environmental telemetry data, statistical descriptors are computed, including mean, variance, rate of change, deviation from predefined acceptable ranges, and cumulative exposure duration outside threshold bands. From transactional data, features such as transfer frequency, average holding duration, geographic displacement velocity, and participant transition probabilities are derived. Graph structural features are computed including node degree distribution, cycle detection indicators, path length variance, clustering coefficients, and motif occurrence frequency. These features collectively form a high-dimensional feature vector representing the behavioral and environmental state of the commodity batch.

The artificial intelligence processor implements a hybrid anomaly detection architecture combining supervised learning and unsupervised learning. In the supervised component, a neural network model is trained using historical labeled data comprising verified authentic and fraudulent supply chain trajectories. The neural network receives the feature vector as input and outputs a probability estimate representing the likelihood of fraudulent behavior. The network parameters are optimized through iterative gradient-based learning to minimize classification error on training datasets. To address concept drift, periodic retraining is performed using newly validated data samples.

In parallel, an unsupervised anomaly detection model evaluates deviations from normative operational baselines without requiring explicit fraud labels. The unsupervised model constructs a baseline distribution of environmental and transactional features using historical authentic data. For each new batch, the model computes statistical distance measures between observed feature values and baseline distributions. Observations exceeding adaptive thresholds determined by percentile-based calibration are marked as anomalous. Additionally, the graph-based representation is processed using a graph neural network configured to learn relational patterns among nodes and edges. The graph neural network propagates node-level features through neighborhood aggregation to detect structural irregularities such as circular trade loops, improbable geographic transitions, and abrupt participant substitutions inconsistent with historical patterns.

The outputs of the supervised neural network, the unsupervised anomaly detection model, and the graph analysis component are aggregated using a weighted scoring mechanism. Each anomaly indicator is assigned a weight determined through validation experiments and domain-specific risk prioritization. The weighted sum of anomaly indicators produces an intermediate behavioral risk score. The system further incorporates authenticity verification through compositional and spectral analysis.

When compositional or spectral data are received from the field-deployable authenticity verification device, the authenticity comparison processor performs preprocessing including calibration correction, noise filtering, baseline normalization, and dimensionality reduction. Feature extraction transforms raw spectral measurements and chemical composition markers into standardized vectors. These vectors are compared against stored reference authenticity profiles obtained from certified origin samples. Similarity evaluation is conducted using distance-based metrics and correlation analysis. The resulting similarity value is converted into an authenticity similarity score, where lower similarity indicates greater likelihood of substitution or adulteration.

The authenticity similarity score is integrated with the behavioral risk score using a weighted aggregation algorithm. Environmental deviation magnitude, identity consistency verification results, and ledger integrity validation status are also incorporated. The final fraud risk score is normalized into a dynamic authenticity index ranging within a predetermined scale. Threshold-based classification categorizes the batch as verified authentic, conditionally authentic requiring inspection, or high-risk fraudulent.

Simultaneously, the cryptographic integrity processor generates a time-stamped hash value for each validated supply chain event record. The hash is computed over the canonical serialized representation of the event node and associated metadata. The generated hash is submitted to a permissioned distributed ledger network where consensus validation confirms inclusion in an immutable record chain. The ledger record stores the hash reference and timestamp, thereby enabling future verification of record integrity. Any subsequent alteration of stored event data produces a hash mismatch, triggering integrity alerts.

The algorithm further incorporates adaptive learning. Confirmed fraud cases and validated authentic batches are fed back into the training dataset. Model parameters are periodically recalibrated to adjust anomaly thresholds and improve predictive accuracy. Drift detection mechanisms monitor distributional changes in feature space to identify when retraining is required. This ensures resilience against evolving fraudulent tactics and seasonal variability in agricultural production.

The field-deployable authenticity verification device contributes to the algorithm by performing local preprocessing and secure transmission. The integrated processing unit executes signal conditioning, feature extraction, and encrypted packet generation before transmitting measurements to the central system. The device’s cryptographic chip generates a unique identity signature for each measurement event, ensuring that authenticity assessments are traceable to verified hardware sources. In cases of network interruption, measurement data are securely stored and transmitted upon connectivity restoration, preserving chronological integrity.

Through the coordinated operation of data harmonization, feature extraction, artificial intelligence-based anomaly detection, compositional similarity analysis, cryptographic anchoring, and adaptive learning, the system establishes a comprehensive and technically robust mechanism for fraud detection and authenticity verification in agricultural supply chains. The algorithmic design ensures scalability across distributed nodes, resilience against data tampering, and continuous improvement through iterative learning, thereby delivering a secure and intelligent solution for agricultural supply chain integrity management.

The system comprises a distributed data acquisition layer configured to collect real-time and batch data from multiple nodes within an agricultural supply chain. At the farm level, data acquisition includes crop origin information, geo-spatial coordinates, harvest time, soil condition indicators, and farmer identification credentials. At transport and storage levels, environmental sensors record temperature, humidity, vibration, gas composition, and container integrity status. Each data packet is digitally signed using secure device-level cryptographic keys to prevent spoofing.

The invention further includes a central processing structure comprising a data harmonization processor configured to transform heterogeneous input formats into a normalized graph-based representation. Each agricultural batch is represented as a structured digital object containing nodes corresponding to origin, transformation stages, custody transfers, and storage events. Edges between nodes represent transactional relationships and temporal transitions. The processor encodes each node with metadata including timestamp, device identifier, participant identity, and environmental parameters.

An artificial intelligence processor is configured to perform fraud detection using supervised and unsupervised learning architectures. In one embodiment, the processor implements anomaly detection using deep neural networks trained on historical legitimate supply chain trajectories. The model evaluates deviations in transport duration, temperature variation profiles, transaction frequency, and participant behavioral consistency. In another embodiment, a graph neural network processes the structured supply chain representation to detect suspicious patterns such as circular trading loops, unusual custody transfers, or improbable geographic transitions.

The authenticity verification component includes spectral and compositional fingerprint analysis. For agricultural commodities such as grains, fruits, spices, oils, or dairy products, the system stores reference chemical and spectral signatures obtained at the source. Upon subsequent scanning, newly captured signatures are compared using similarity scoring algorithms, including cosine similarity and statistical distance metrics. If the similarity falls below a predefined adaptive threshold, the batch is flagged for potential substitution or adulteration.

To ensure data integrity, each verified transaction is hashed using a cryptographic hashing algorithm. The hash is anchored into a distributed ledger structure, thereby creating an immutable record of the event. The ledger structure is permissioned and accessible only to authorized participants. The system includes a consensus validation processor configured to verify new entries based on digital signatures and network agreement rules. Any attempt to alter historical data results in hash mismatch detection.

The method of fraud detection includes the steps of acquiring multimodal supply chain data, generating structured digital representations of agricultural batches, applying artificial intelligence-based anomaly detection algorithms, computing authenticity similarity scores, cryptographically anchoring validated records, and issuing risk classification outputs. The system generates a dynamic fraud risk index for each batch, calculated using weighted aggregation of anomaly scores, environmental deviations, identity inconsistencies, and spectral mismatch levels. This index is continuously updated as new data is received.

The invention further provides a physical device structured as an Agricultural Authenticity Verification and Fraud Detection Machine. The device comprises a rigid housing structure fabricated from impact-resistant composite material suitable for field deployment. The housing encloses an integrated processing unit, a multi-sensor acquisition assembly, a cryptographic security chip, and a communication interface.

The multi-sensor acquisition assembly includes a near-infrared spectroscopy sensor configured to capture spectral fingerprints of agricultural commodities, a chemical detection sensor configured to analyze compositional markers, a high-resolution imaging sensor configured to capture visual texture and morphological features, and environmental sensors configured to record ambient temperature and humidity during testing. The sensors are operatively connected to an internal processor through shielded signal pathways to prevent interference.

The integrated processing unit is configured to perform preliminary data preprocessing including noise reduction, normalization, and feature extraction. The unit generates a secure data packet containing extracted features and raw measurement identifiers. A tamper-resistant cryptographic chip embedded within the device generates a digital signature unique to the device identity, thereby ensuring authenticity of the measurement source.

The device further comprises a wireless communication interface configured to transmit signed data packets to a central or distributed fraud analytics server using encrypted communication protocols. A local display interface provides real-time authenticity status output including risk classification indicators and similarity scores. The structure further includes a secure memory component configured to temporarily store measurement logs in the event of network unavailability.

The machine structure is configured to operate in portable mode using rechargeable battery power and may further include docking capability for stationary warehouse integration. Structural reinforcements within the housing prevent mechanical shock from affecting sensor calibration, thereby maintaining measurement accuracy under field conditions.

The present invention provides end-to-end intelligent fraud detection across agricultural supply chains by integrating artificial intelligence, sensor-based authentication, and cryptographic integrity verification. The system reduces economic losses caused by counterfeit or adulterated products, enhances consumer trust, improves regulatory compliance, and enables real-time risk monitoring. The dedicated verification device ensures authenticity validation at source and at multiple supply chain checkpoints, thereby significantly reducing the possibility of undetected tampering.

The disclosed system and method for fraud detection and authenticity verification in agricultural supply chains using artificial intelligence introduces a technologically advanced framework that integrates multimodal data acquisition, structured supply chain modeling, machine learning-based anomaly detection, cryptographic ledger anchoring, and a dedicated authentication device. The invention provides a secure, scalable, and adaptive mechanism for ensuring agricultural product authenticity and preventing fraud across distributed supply chain ecosystems.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for fraud detection and authenticity verification in agricultural supply chains using artificial intelligence, comprising:
a distributed data acquisition unit configured to receive multimodal data associated with an agricultural commodity batch from a plurality of supply chain nodes including origin sites, transportation carriers, storage facilities, processing centers, and distribution points;
a data harmonization processor operatively connected to the distributed data acquisition unit and configured to transform heterogeneous input data into a normalized structured digital representation comprising interconnected nodes representing custody events and temporal transitions;
an artificial intelligence processor configured to analyze the structured digital representation to detect anomalies in transactional behavior, environmental conditions, and participant identity patterns, and to generate a fraud risk score for the agricultural commodity batch;
a cryptographic integrity processor configured to generate a unique hash value corresponding to each validated supply chain event and to anchor the hash value into a distributed ledger record; and
a communication interface configured to transmit risk classification outputs and authenticity verification results to authorized stakeholder devices, and wherein the communication interface is configured to transmit the fraud risk score, authenticity similarity score, and integrity validation status as a composite authenticity index embedded within a digitally signed response packet, and wherein the digitally signed response packet includes a verifiable reference to the anchored distributed ledger record corresponding to the agricultural commodity batch, such that authorized stakeholder devices can independently validate the authenticity index against the distributed ledger record and the associated structured digital representation.

2. The system of claim 1, wherein the distributed data acquisition unit comprises a plurality of sensor interfaces configured to collect temperature, humidity, vibration, atmospheric composition, geo-spatial coordinates, timestamp metadata, participant identity credentials, and packaging identifier data, and wherein each data packet is digitally signed using a device-level cryptographic key prior to transmission to the data harmonization processor, and wherein the data harmonization processor is configured to generate a graph-based representation of the agricultural commodity batch in which each node includes metadata fields comprising event timestamp, physical location coordinates, participant identifier, environmental parameter set, and transaction classification, and wherein edges between nodes represent sequential custody transfers validated through digital signature verification.

3. The system of claim 1, wherein the artificial intelligence processor comprises a neural network model trained using historical supply chain trajectories of verified authentic batches, the neural network model being configured to detect deviations in transport duration profiles, environmental parameter distributions, custody frequency patterns, and geographic transition sequences exceeding adaptive threshold criteria derived from statistical baseline modeling, and wherein the artificial intelligence processor further comprises a graph analysis unit configured to evaluate structural irregularities within the graph-based representation, including circular transaction patterns, abrupt participant substitutions, inconsistent geographic progression, and abnormal transaction density, and to assign weighted anomaly indicators contributing to the fraud risk score.

4. The system of claim 1, further comprising an authenticity comparison processor configured to receive compositional and spectral signature data corresponding to the agricultural commodity batch, compare the received data with stored reference authenticity profiles using similarity evaluation algorithms, and generate an authenticity similarity score that is incorporated into the fraud risk score through weighted aggregation, and wherein the authenticity comparison processor is configured to process spectral data obtained from near-infrared measurements, visual texture data obtained from high-resolution imaging, and chemical composition markers obtained from sensor analysis, and wherein feature extraction is performed using normalization, noise filtering, and dimensionality reduction prior to similarity computation.

5. The system of claim 1, wherein the cryptographic integrity processor is configured to verify digital signatures of incoming data packets, generate a time-stamped cryptographic hash value for each validated event record, and submit the hash value to a permissioned distributed ledger network for consensus validation, thereby creating an immutable audit record linked to the structured digital representation, and further comprising a field-deployable authenticity verification device communicatively coupled to the distributed data acquisition unit, the device including a housing structure enclosing an integrated processing unit, a multi-sensor acquisition assembly comprising a spectral sensor, a chemical detection sensor, a high-resolution imaging sensor, and environmental sensors, and a tamper-resistant cryptographic chip configured to generate a unique device identity signature for each measurement event transmitted to the system.

6. The system of claim 9 wherein the integrated processing unit of the field-deployable authenticity verification device is configured to perform local preprocessing including signal calibration, feature extraction, normalization, and encrypted packet generation, and wherein the communication interface is configured to transmit the encrypted packet to the artificial intelligence processor through a secure wireless protocol while temporarily storing measurement logs in a secure memory component during network unavailability, thereby ensuring continuity and integrity of authenticity verification operations.

7. The system of claim 2, wherein the data harmonization processor is configured to perform temporal reconciliation of multimodal data by aligning timestamp metadata received from the plurality of supply chain nodes to a unified coordinated time reference through drift correction based on cryptographically verified time sources, and wherein the data harmonization processor further resolves conflicting custody events by applying precedence rules derived from verified digital signatures and geo-spatial proximity validation such that only chronologically and geographically consistent node sequences are incorporated into the normalized structured digital representation.

8. The system of claim 2, wherein the data harmonization processor is further configured to generate, for each interconnected node, a multi-dimensional event vector comprising environmental statistical descriptors calculated over a sliding time window, transaction frequency metrics computed relative to historical averages for a corresponding participant identifier, and geo-spatial transition parameters derived from successive location coordinates, and wherein the multi-dimensional event vector is appended to the corresponding node prior to analysis by the artificial intelligence processor.

9. The system of claim 3, wherein the artificial intelligence processor is configured to generate a baseline behavioral profile for each participant identifier by aggregating historical custody events associated with that participant identifier, computing probabilistic transition matrices representing typical source-to-destination movement patterns, and comparing real-time custody transitions of the agricultural commodity batch against the probabilistic transition matrices to identify statistically improbable transfer sequences exceeding adaptive deviation thresholds dynamically recalculated based on cumulative historical variance.

10. The system of claim 3, wherein the artificial intelligence processor is further configured to perform sequential anomaly detection by encoding temporally ordered nodes of the structured digital representation into a contextual embedding space, generating predicted subsequent event vectors based on preceding node embeddings, and computing a divergence score between predicted event vectors and actual observed event vectors, the divergence score contributing proportionally to the fraud risk score when exceeding a dynamically adjusted tolerance interval, and wherein the graph analysis unit is configured to compute structural entropy values for subgraphs corresponding to individual agricultural commodity batches, compare the computed structural entropy values with reference entropy ranges derived from verified authentic supply chain graphs, and assign anomaly weights to the fraud risk score when the structural entropy values deviate beyond a statistically defined confidence boundary.

11. The system of claim 4, wherein the authenticity comparison processor is configured to construct a reference authenticity profile library indexed by commodity type, geographic origin, harvest season, and processing classification, and wherein the processor selects a subset of reference profiles based on metadata contained within the structured digital representation prior to performing similarity evaluation, thereby restricting comparison to contextually relevant authenticity baselines.

12. The system of claim 4, wherein the authenticity comparison processor is further configured to apply adaptive spectral calibration by compensating received spectral data for ambient temperature and humidity values recorded by the distributed data acquisition unit, adjusting baseline offsets using calibration coefficients stored in association with the spectral sensor, and generating a corrected spectral feature vector prior to dimensionality reduction and similarity computation, and wherein the authenticity similarity score is computed by aggregating multiple similarity measures derived independently from spectral features, visual texture descriptors, and chemical composition markers, and wherein weighting coefficients applied to the multiple similarity measures are dynamically adjusted based on a reliability index calculated from signal-to-noise ratios and calibration status of the multi-sensor acquisition assembly.

13. The system of claim 5, wherein the cryptographic integrity processor is configured to compute the time-stamped cryptographic hash value over a canonical serialized representation of each validated supply chain event including node metadata, multi-dimensional event vectors, and authenticity similarity scores, and wherein the canonical serialized representation is deterministically ordered to ensure identical hash generation across distributed verification instances, and wherein the cryptographic integrity processor is further configured to perform periodic integrity audits by recalculating hash values from stored structured digital representations, retrieving corresponding anchored hash values from the distributed ledger record, and identifying discrepancies through hash comparison, and wherein identified discrepancies trigger generation of a tamper alert transmitted through the communication interface.

14. The system of claim 6, wherein the integrated processing unit of the field-deployable authenticity verification device is configured to perform real-time feature extraction by applying digital filtering to remove high-frequency noise components from raw sensor signals, executing baseline normalization using calibration reference measurements stored within the secure memory component, and generating a compact feature representation suitable for encrypted transmission to the artificial intelligence processor, and wherein the tamper-resistant cryptographic chip is configured to generate a device identity signature by computing a cryptographic digest over the extracted feature representation and a device-unique private key stored within a secure enclave, and wherein the generated device identity signature is verified by the cryptographic integrity processor prior to acceptance of compositional and spectral signature data for authenticity comparison.

15. The system of claim 3, wherein the artificial intelligence processor is configured to update adaptive threshold criteria by periodically recalculating statistical baseline parameters using newly validated structured digital representations and confirmed fraud instances, adjusting weighting coefficients of anomaly indicators through iterative optimization based on misclassification error minimization, and applying the updated threshold criteria to subsequent fraud risk score computations without interrupting ongoing data acquisition.
